(19) United States
(12) Patent Application Publication
(10) Pub. No.: US 2010/0007592 A1
(43) Pub. Date: Jan. 14, 2010

(54) Controlling the brightness control signal for a pixel of a liquid crystal display

(76) Inventors: Gino Priem, Zingem (BE); Bart Maximus, Oudenaarde (BE)

Correspondence Address: BACON & THOMAS, PLLC, 625 SLATERS LANE, FOURTH FLOOR, ALEXANDRIA, VA, 22314-1176, US

(21) Appl. No.: 12/216,851

(22) Filed: Jul. 11, 2008

(30) Foreign Application Priority Data
Jul. 10, 2008 (CA) 2637477

(51) Int. Cl. G09G 3/36

(52) U.S. Cl. 345/89

(57) ABSTRACT

The invention relates to controlling the brightness control signal for a pixel of a liquid crystal display. According to the invention, a method of controlling the brightness control signal for a first pixel of a liquid crystal display for displaying a predetermined image is provided, comprising the following steps: determining the intended brightness of the first pixel according to the predetermined image, determining the brightness of a second pixel, and calculating the brightness control signal for the first pixel on the basis of a function of the intended brightness of the first pixel and the brightness of the second pixel, wherein the function is a predetermined correction function according to which the influence of the brightness of the second pixel on the brightness of the first pixel due to fringe field effects between the first pixel and the second pixel is corrected. This method provides for the advantage that a more realistic image can be displayed.

The invention relates to a method and a system for controlling the brightness control signal for a pixel of a liquid crystal display, and especially to a method and system for reducing brightness indication errors due to fringe field effects between neighboring pixels.

### TECHNICAL BACKGROUND

The operation of a liquid crystal display basically consists of applying an electric field to a liquid crystal layer, and, thus, changing its optical properties. This allows for changing the polarization of light incident to the display. For example, an electric field can be applied by placing the liquid crystal layer between two electrodes and applying a voltage to these electrodes. If a display is combined with one or more polarizers, a change of polarization can be converted into an intensity change and, thus, grayscale images can be generated.

Liquid crystal displays typically comprise one or more elements for individually controlling the electric field, i.e. pixels or sub-pixels. The electric field, however, cannot be considered to be uniform over the complete pixel area since fringe field effects at the pixel edges occur which have an effect on the optical performance of liquid crystal displays. Especially, reduced brightness, fuzzy pixel edges and/or domains with different brightnesses can be observed.

The magnitude of fringe field effects depends, among others, on the thickness of liquid crystal layer, the size of the pixels, the inter-pixel gap, the liquid crystal orientation, the liquid crystal pre-tilt and direction etc. In particular, displays based on LCOS (Liquid Crystal On Silicon) technology are very sensitive to fringe field effects because of their typically small inter-pixel gap.

For instance, in high resolution LCOS micro displays which can be used for projection applications, this may lead to severe image distortions. For example, incorrect image brightness might occur. The brightness of a white pixel surrounded by black pixels can be significantly smaller than the brightness of a white pixel surrounded by white pixels. Another example is that the brightness of line structures which are a few pixels wide can depend on the direction of the line on the liquid crystal display.

Further, in configurations with more than one panel, this may lead to discolorations which do not correspond to the original image data. Typically, in 3-panel configurations, the properties of the panel in the green channel are mirrored compared to the properties of the panels in the red and the blue channel due to an extra mirroring operation of the combining optics. As a result, due to the fringe field effects described above, the color of line structures which are a few pixel wide can also depend on the direction of the line on the liquid crystal display.

Moreover, a combination of both effects also gives rise to what can be described as significant aliasing effects. For example, the reproduction of a line with a required brightness level may lead to unwanted modulation effects.

Several approaches exist to reduce the impact of fringe fields on the image quality for a given liquid crystal display. For example, in EP 1 225 558 A1 a liquid crystal display system is described which comprises a mini display or micro display system with a matrix of pixels, wherein a video data stream is analyzed for a grayscale level jumps from extreme black to moderate gray levels. Transitions in grayscale levels are restricted between adjacent pixels so as to reduce image degradation, i.e. disclination due to fringe field effects. A memory may be used to store a previous row of video data or one or more adjacent pixel video data values before and/or after modification. Grayscale levels to be written to adjacent pixels are compared by a video data comparator/modifier, and if a difference between these grayscale levels exceeds a certain value then at least one of the grayscale levels is modified.

Further, according to EP 1 225 558 A1, the maximum voltage difference between adjacent pixels is limited. This approach can solve the possible visibility of fringe fields but can also introduce some amount of blur or a limitation of the available resolution and does not relate to displaying the correct brightness or solving aliasing effects. In high resolution and/or high limiting configurations, direct fringe fields visibility is limited, but its effects such as incorrect image brightness, discoloration and aliasing, may be more important.

An approach to solve the discoloration in multiple panel systems is using two types of liquid crystal displays with mirrored properties. This approach, however, does not solve such effects as incorrect image brightness and aliasing. It solves discoloration, but converts it into incorrect brightness performance.

### SUMMARY OF THE INVENTION

It is the object of the invention to provide a method and a system for controlling the brightness control signal for a pixel of a liquid crystal display, wherein the difference between the perceived brightness of a pixel and the intended brightness of the pixel is reduced.

This object is achieved by a method of controlling the brightness control signal for a first pixel of a liquid crystal display for displaying a predetermined image, comprising the following steps:
determining the intended brightness of the first pixel according to the predetermined image,
determining the brightness of a second pixel, and
calculating the brightness control signal for the first pixel on the basis of a function of the intended brightness of the first pixel and the brightness of the second pixel, wherein
the function is a predetermined correction function according to which the influence of the brightness of the second pixel on the brightness of the first pixel due to fringe field effects between the first pixel and the second pixel is corrected. It is included within the scope of the present invention that the difference between the perceived and intended brightness is reduced, but it can be that—to achieve this—the fringe field influence is increased.

The brightness control signal is understood to be the signal which controls the brightness of a pixel. For example, this can be a voltage or any other suitable control signal. Accordingly, it is an essential idea of the invention to compensate for fringe field effects due to neighboring pixels onto the brightness of a pixel by taking into account such interactions on the basis of a correction function. In other words, it is the idea of this invention to recalculate the brightness value of a pixel of a predetermined image based on a multi-pixel approach, i.e. taking into account the intended brightness of the pixel and at least the brightness of another, preferably neighboring pixel, in order to display the image on a liquid crystal display more realistically for an observer.

In general, the brightness of the second pixel can already be such a brightness which is determined by a method as described above, i.e. which is determined taking into account at least fringe field effects from one neighboring pixel. However, according to a preferred embodiment of the invention, the brightness of the second pixel is the intended brightness of the second pixel according to the predetermined image. In this way, a fast and efficient method is provided since multiple iteration steps are avoided.

Further, generally the predetermined correction function can be implemented as an analytical function. However, according to a preferred embodiment of the invention, the predetermined correction function is implemented as a look-up table. Such a look-up table preferably directly allocates a pixel control voltage as a brightness control signal to a set of the intended brightness of the first pixel and the brightness of the second pixel in a unique way. Alternatively, according to another preferred embodiment of the invention, the correction function uniquely allocates the corrected brightness for controlling the first pixel to a set of the intended brightness of the first pixel and the brightness of the second pixel.

Generally, taking into account only one second pixel for calculating the brightness control signal for the first pixel might already reduce fringe field effects on a correct brightness indication. However, according to a preferred embodiment of the invention, multiple second pixels are taken into account for calculating the brightness control signal for the first pixel. With respect to this, it is especially preferred that all such neighboring pixels are taken into account which actually effect the brightness of the first pixel due to fringe field effects. These might be directly neighboring pixels, however, even pixels which are separated from the first pixel by at least one intermediate pixel or even more intermediate pixels can be taken into account. Hence the term “neighbor” should be construed more broadly than “nearest neighbor”.

Further, according to a preferred embodiment of the invention, the brightness control signals from multiple first pixels, preferably for all pixels of the liquid crystal display, are calculated. This means that preferably a brightness correction with respect to fringe field effects is performed for the complete image and or the complete display, respectively. However, according to a preferred embodiment of the invention, it is also possible that a set of first pixels which might comprise only some of the pixels of the liquid crystal display, for which the brightness control signal is calculated is dynamically defined based on changes of the predetermined image in time. This means that according to this preferred embodiment of the invention, only such parts of the image are treated with respect to brightness correction which actually require such correction due to their image content. With respect to this, it is especially preferred that as changes of the predetermined image in time, spatial and/or frequency information of the predetermined image are considered. This means that it is analysed which part of the image on the basis of spatial and/or frequency information comprises the highest requirement for brightness correction in order to provide a realistic displayed image. According to another preferred embodiment of the invention, the image parts which require corrections can be provided through a separate data path, which is added at a different time, e.g. later on to the rest of the image. For example, in an application with crucial flight information, the image may be enhanced with very small intense lights such as light points on the runway at a different time.

Since the correction function according to the invention can be rather complex, a case might occur in which different calculated brightness control signals are calculated for multiple first pixels with identical intended brightness according to the predetermined image. In such a case, according to a preferred embodiment of the invention, the calculated brightness control signals for these multiple first pixels are set to the lowest of these brightness control signals in common. Though the image might loose contrast in this way and might be perceived “darker”, brightness is indicated in a consistent way, i.e. pixels with intended identical brightness are not controlled in different ways due to the fringe field effects compensation.

Above-mentioned object is further addressed by a system for controlling the brightness control signal for a first pixel of a liquid crystal display for displaying a predetermined image, comprising:
a brightness determination unit which is adapted for determining the intended brightness of the first pixel according to the predetermined image and for determining the brightness of a second pixel, and
a calculator which is adapted for calculating the brightness control signal for the first pixel on the basis of a function of the intended brightness of the first pixel and the brightness of the second pixel, wherein the function is a predetermined correction function according to which the influence of the brightness of the second pixel on the brightness of the first pixel due to fringe field effects between the first pixel and the second pixel is corrected.

Above-mentioned object is further addressed by a controller for controlling the brightness control signal for a first pixel of a liquid crystal display for displaying a predetermined image, comprising:
a calculator which is adapted for calculating the brightness control signal for the first pixel on the basis of a function of the intended brightness of the first pixel and the brightness of the second pixel, wherein the function is a predetermined correction function according to which the influence of the brightness of the second pixel on the brightness of the first pixel due to fringe field effects between the first pixel and the second pixel is corrected.

Preferred embodiments of this system relate to the preferred embodiments of the method described above. In detail:

According to a preferred embodiment of the invention, the predetermined correction function is provided as a look-up table. Further, it is preferred that the calculator is adapted for taking into account multiple second pixels for calculating the brightness control signal for the first pixel. Furthermore, according to a preferred embodiment of the invention, the calculator is adapted for calculating brightness control signals for multiple first pixels, preferably for all pixels of liquid crystal display.

Moreover, the invention also relates to a liquid crystal display device with a system as described above. Such liquid crystal display device may preferably be used for simulation purposes, especially for nightflight simulation.

### BRIEF DESCRIPTION OF THE DRAWINGS

These and other aspects of the invention will be apparent from and illucidated with reference to the embodiments described hereinafter.

In the drawings:

FIG. 1 schematically depicts the determination of pixel data for a first pixel according to an embodiment of the invention,

FIG. 2 schematically depicts the determination of pixel data for different first pixels according to an embodiment of the invention,

FIG. 3 schematically depicts the determination of pixel data for first pixels of different colour channels according to an embodiment of the invention,

FIG. 4 schematically depicts brightness adaption of different pixels according to an embodiment of the invention, and

FIG. 5 schematically depicts brightness adaption of different pixels according to another embodiment of the invention.

FIG. 6 schematically depicts a display according to an embodiment of the invention.

### DESCRIPTION OF THE ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

Similarly, it is to be noticed that the term “coupled”, also used in the claims, should not be interpreted as being restricted to direct connections only. Thus, the scope of the expression “a device A coupled to a device B” should not be limited to devices or systems wherein an output of device A is directly connected to an input of device B. It means that there exists a path between an output of A and an input of B which may be a path including other devices or means.

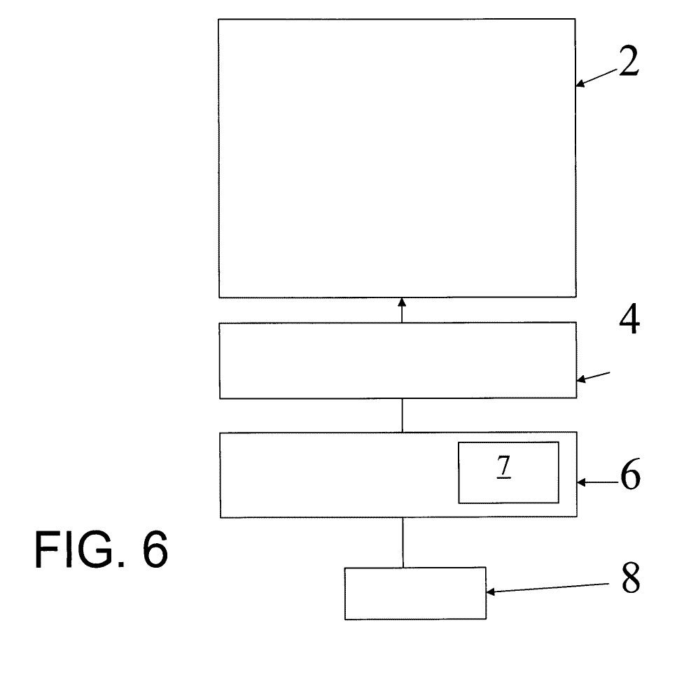

FIG. 6 is a schematic representation of a display system according to an embodiment of the present invention including a signal source 8, a controller unit 6, a driver 4 and a display 2 with a matrix of pixel elements 10 that are driven by the driver 4. The display is for example a liquid crystal display, e.g. an LCOS display.

To display a certain grayscale, a liquid crystal display is characterized by means of its electro-optical transfer function which is typically S-shaped. This S-curve can be obtained by measurement and/or simulations and only takes into account a single pixel. Unwanted grayscale variations in the display visible on uniformly expected gray patterns can be additionally compensated by a uniformity correction on top of this transfer function. Such non-uniformities can be caused by thickness variations. However, the method proposed by the present invention goes beyond such correction.

An aspect of the present invention is the recalculation of the pixel values of an image based on a multi-pixel approach in order to display the image on a liquid crystal display more realistically. According to an embodiment of the invention, this approach comprises a set of one or more liquid crystal displays and a characterization of the optical interaction between a set of pixels or sub-pixels in a specific area as a function of the electrical signals provided to these pixels or sub-pixels, respectively. This characterization can describe the brightness variation of some of the pixels in the area depending on the electrical signal provided to other pixels in the considered area. Further, this approach according to the embodiment of the invention comprises a derivation of the required electrical signals which will be provided to some of the pixels or sub-pixels in the considered area to obtain improved optical properties of the considered pixel area, when the other pixel or sub-pixel signals in the configuration are present or already provided during a previous derivation which is referred to as the “transfer function”.

In the following, pixels or sub-pixels of which the electrical signals are derived are indicated by capital letters while the other pixels in the considered pixel area are indicated by small letters. Further, the approach according to the embodiment of the invention comprises a device to apply this derivation in a preferably continuous way for each pixel or sub-pixel for which the correction is applied and for each image which is considered. Preferably, this is done in real time, however, non-real time solutions are possible, too.

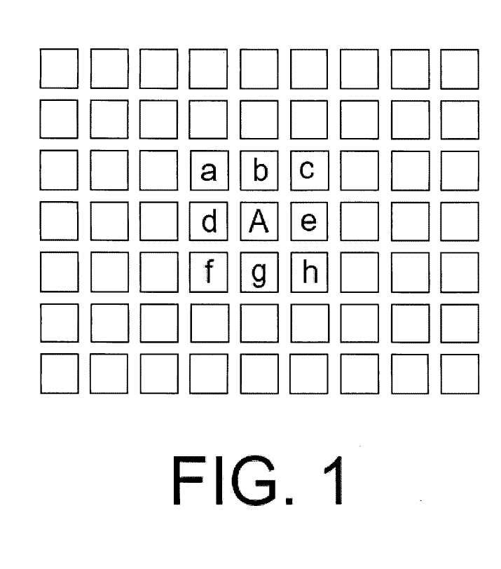

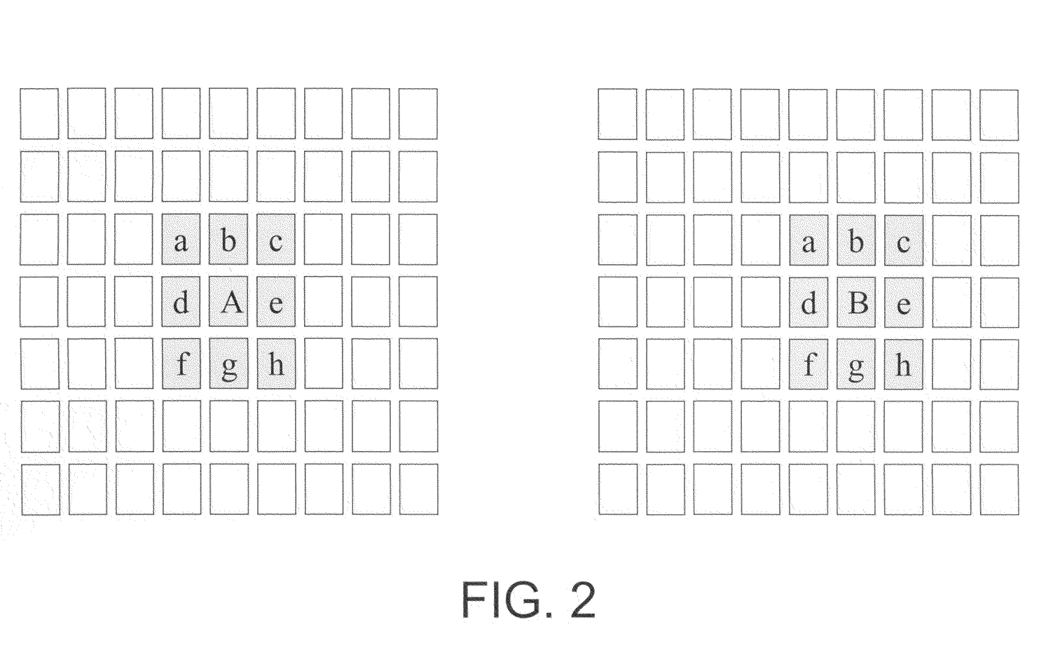

Such an embodiment of the invention is schematically depicted in FIG. 1. In the following, a display is characterized by considering the electrical properties of multiple pixels A, a, b, c, d, e, f, g and h to determine the optical properties of some of these pixels, e.g. the pixel brightness of a pixel A. Due to fringe field effects, the brightness of a single grey pixel A will be different if it is surrounded by e.g. black pixels or white pixels, respectively. To compensate for this effect, a transfer function is determined for a pixel which also takes into account the pixel data of a selected area of pixels, in this case all adjacent pixels a, b, c, d, e, f, g and h. The pixel data of the other pixels a, b, c, d, e, f, g and h can be the original, i.e. uncorrected, value or a value which has already been obtained in a previous transfer function calculation. At the edges of the panel, boundary conditions may apply. A similar procedure is used to obtain the corrected data for another pixel B by considering the pixels B, a′, b′, c′, d′, e′, f′, g′ and h′, as shown in FIG. 2. The derivation of the pixel data for a pixel B may be simultaneous to the derivation for pixel A or can be done sequentially.

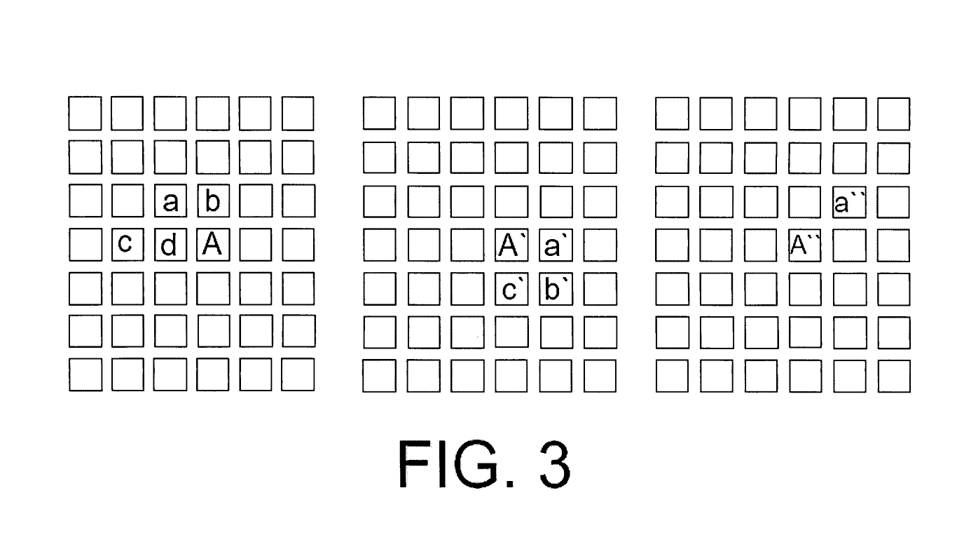

The amount and the position of the pixels taken into account in FIGS. 1 and 2, respectively, are only exemplary. In particular, the additional pixels which are taken into account can be positioned in an asymmetric way around the pixel A, as shown in FIG. 3. For the red, the green and the blue color channel, respectively. From this Figure it can be seen that the positioning of the additional pixels can be different for different colors, both in case a single or multiple panels are used for the different colors. The considered pixel area can also vary for different pixels.

The characterization and derivation of such a transfer function can be by measurements or simulations or any other appropriate approach. Measurements to characterize and derive the transfer function can for instance consist of providing designated patterns to the set of one or more liquid crystal displays, which triggers specific interactions between the different pixels in a considered area of pixels, and of measuring the obtained optical response.

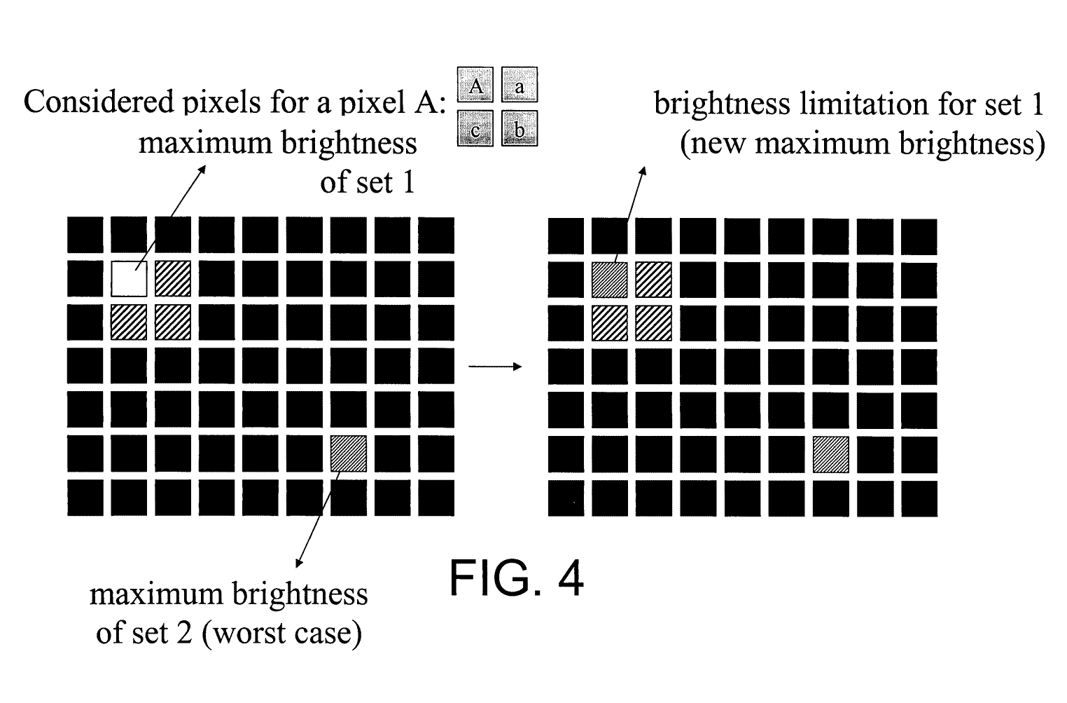

To allow for optimum image quality, the transfer function may have a reference value which can be obtained for all considered pixel values or electrical signals of the considered pixels or sub-pixels, a, b, c, . . . The maximum brightness of a pixel A for a given driving range in a set 1 of the considered pixel values for the pixels a, b, c, . . . can be lower than the maximum brightness of the same pixel in another set 2 of considered pixel values for the same pixels a, b, c, . . . Due to fringe field effects, the maximum brightness of a single pixel surrounded by black pixels can be significantly lower than the maximum brightness of the same pixel surrounded by equally driven pixels. According to one embodiment of the invention, it is the target to display any grayscale image as realistic as possible. The maximum pixel brightness of a pixel A for any set of pixel values for the considered pixels a, b, c, . . . can then be limited to the lowest maximum pixel brightness for the pixel. This is shown in FIG. 4 which shows the considered pixel A and the considered second pixel configuration. The brightness of the considered first pixels on the right image are identical.

According to another embodiment of the invention, the transfer function may have a reference value which can only be obtained for some of the considered pixel values or electrical signals of the considered pixels or sub-pixels a, b, c, . . . This situation can for instance be preferred when some distortion can be tolerated not to limit other optical properties. A second best effort transfer function may then be considered for the pixels values for which the reference value cannot be obtained. This reference value can be any other criterium than maximum pixel brightness used in the examples above. More than one criterium can also be possible, e.g. minimum and maximum pixel brightness.

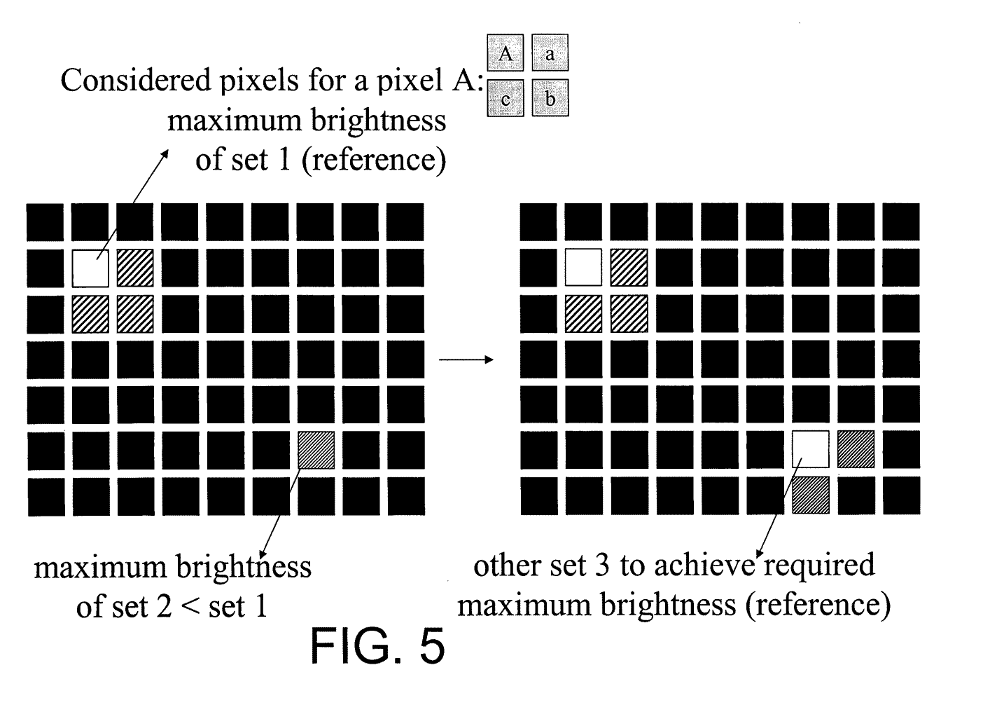

According to still another embodiment of the invention, when a transfer function is used which has a reference value which can only be obtained for some of the considered pixel values or electrical signals of the considered pixels or sub-pixels a, b, c, . . . , a limitation for a specific set of pixel values for the pixel a, b, c, . . . may be overcome by changing to another set of pixel values for the pixels a, b, c, . . . For example, if it is supposed that a maximum brightness of a set 1 is higher than that of a set 2 as shown in FIG. 5, by changing from set 2 to set 3 of considered values, the maximum brightness can be improved significantly due to the fringe fields of the considered pixels. FIG. 5 shows the considered pixel A and the considered second pixels. The correct brightness for the first pixels is obtained by changing ‘second pixels’ to set 3 in the bottom right in the right image.

Depending on the content, it can be preferred to use the multi-pixel approach only for a part of the display. This part may be selected by considering the spatial and/or frequency information of an image or any other means. In particular, this improvement may be applied to data which is more crucial for an application than another. By applying a similar approach to all display elements in a device, this coloration due to fringe fields effects can be significantly improved.

The present invention also provides a controller 6 (FIG. 6) for controlling the brightness control signal for a first pixel of a liquid crystal display for displaying a predetermined image. The controller includes a calculator 7 which is adapted for calculating the brightness control signal for the first pixel on the basis of a function of the intended brightness of the first pixel and the brightness of the second pixel, wherein the function is a predetermined correction function according to which the influence of the brightness of the second pixel on the brightness of the first pixel due to fringe field effects between the first pixel and the second pixel is corrected. Any of the functionality of the controller 6 may be implemented as hardware, computer software, or combinations of both. The calculator may be implemented with a general purpose processor, an embedded processor, a digital signal processor (DSP), an application specific integrated circuit (ASIC), a field programmable gate array (FPGA) or other programmable logic device, discrete gate or transistor logic, discrete hardware components, or any combination designed to perform the functions described herein. A general purpose processor may be a microprocessor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. Method of controlling the brightness control signal for a first pixel of a liquid crystal display for displaying a predetermined image, comprising the following steps:
determining the intended brightness of the first pixel according to the predetermined image,
determining the brightness of a second pixel, and
calculating the brightness control signal for the first pixel on the basis of a function of the intended brightness of the first pixel and the brightness of the second pixel, wherein
the function is a predetermined correction function according to which the influence of the brightness of the second pixel on the brightness of the first pixel due to fringe field effects between the first pixel and the second pixel is corrected.

2. Method according to claim 1, wherein the brightness of the second pixel is the intended brightness of the second pixel according to the predetermined image.

3. Method according to claim 1, wherein the predetermined correction function is implemented as a look-up table.

4. Method according to claim 1, wherein the correction function uniquely allocates a corrected brightness for controlling the first pixel to the set of the intended brightness of the first pixel and the brightness of the second pixel.

5. Method according to claim 1, wherein multiple second pixels are taken into account for calculating the brightness control signal for the first pixel.

6. Method according to claim 1, wherein the brightness control signals for multiple first pixels, preferably for all pixels of the liquid crystal display, are calculated.

7. Method according to claim 1, wherein a set of first pixels for which the brightness control signal is calculated is dynamically defined based on changes of the predetermined image in time.

8. Method according to claim 1, wherein a set of first pixels for which the brightness control signal is calculated, is added through a separate data path.

9. Method according to claim 7, wherein spatial and/or frequency information of the predetermined image are considered as changes of the predetermined image in time.

10. Method according to claim 1, wherein in case of different calculated brightness control signals for multiple first pixels with identical intended brightness, the calculated brightness control signals for these multiple first pixels are in common set to the lowest of these brightness control signals.

11. Method according to claim 1, wherein in case of different calculated brightness control signals for multiple first pixels with identical intended brightness, the calculated brightness control signals for these multiple first pixels are set to a reference brightness with an best effort transfer function when the reference brightness cannot be achieved.

12. Method according to claim 1, wherein in case of different calculated brightness control signals for multiple first pixels with identical intended brightness, the calculated brightness control signals for these multiple first pixels are set to a reference brightness and when the reference brightness cannot be achieved, the second pixel is changed.

13. System for controlling the brightness control signal for a first pixel of a liquid crystal display for displaying a predetermined image, comprising:
a brightness determination unit which is adapted for determining the intended brightness of the first pixel according to the predetermined image and for determining the brightness of a second pixel, and
a calculator which is adapted for calculating the brightness control signal for the first pixel on the basis of a function of the intended brightness of the first pixel and the brightness of the second pixel, wherein the function is a predetermined correction function according to which the influence of the brightness of the second pixel on the brightness of the first pixel due to fringe field effects between the first pixel and the second pixel is corrected.

14. System according to claim 13, wherein the predetermined correction function is provided as a look-up table.

15. System according to claim 13, wherein the calculator is adapted for taking into account multiple second pixels for calculating the brightness control signal for the first pixel.

16. System according to claim 13, wherein the calculator is adapted for calculating brightness control signals for multiple first pixels, preferably for all pixels of the liquid crystal display.

17. Liquid crystal display device having means for controlling the brightness control signal for a first pixel of a liquid crystal display for displaying a predetermined image, comprising:
a brightness determination unit which is adapted for determining the intended brightness of the first pixel according to the predetermined image and for determining the brightness of a second pixel, and
a calculator which is adapted for calculating the brightness control signal for the first pixel on the basis of a function of the intended brightness of the first pixel and the brightness of the second pixel, wherein the function is a predetermined correction function according to which the influence of the brightness of the second pixel on the brightness of the first pixel due to fringe field effects between the first pixel and the second pixel is corrected.

18. Device according to claim 17, wherein the predetermined correction function is provided as a look-up table.

19. Device according to claim 17, wherein the calculator is adapted for taking into account multiple second pixels for calculating the brightness control signal for the first pixel.

20. Device according to claim 17, wherein the calculator is adapted for calculating brightness control signals for at least multiple first pixels and optionally for all pixels of the liquid crystal display.

21. A controller for controlling the brightness control signal for a first pixel of a liquid crystal display for displaying a predetermined image, comprising:
a calculator which is adapted for calculating a brightness control signal for the first pixel on the basis of a function of the intended brightness of the first pixel and the brightness of a second pixel, wherein the function is a predetermined correction function according to which the influence of the brightness of the second pixel on the brightness of the first pixel due to fringe field effects between the first pixel and the second pixel is corrected.

22. The controller according to claim 21, wherein the calculator is adapted for taking into account multiple second pixels for calculating the brightness control signal for the first pixel.

23. The controller of claim 21, wherein the calculator is adapted for calculating brightness control signals for multiple first pixels, preferably for all pixels of the liquid crystal display.
